(19) United States
(12) Patent Application Publication
(10) Pub. No.: US 2002/0195897 A1
(43) Pub. Date: Dec. 26, 2002

(54) DEVICE IN THE STATOR OF A ROTATING ELECTRIC MACHINE

(76) Inventors: MATS LEIJON, VASTERAS (SE); BERTIL LARSSON, VASTERAS (SE); HANS-OLOF KALLDIN, VASTERAS (SE); SOREN BERGGREN, VASTERAS (SE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 09/194,567

(22) PCT Filed: May 27, 1997
(86) PCT No.: PCT/SE97/00899

(30) Foreign Application Priority Data
May 29, 1996 (SE) 9602079-7
May 29, 1996 (SE) 9602096-1

(51) Int. Cl. H02K 3/00

(52) U.S. Cl. 310/179

(57) ABSTRACT

A device for avoiding wear between the cables in coilend packages on the stator (1) in a rotating electric machine comprises a resilient layer (10) in the contact area between two cables (4). The cables (4) are mutually secured by a securing device (12). The resilient layer (10) permits a certain relative movement between the cable (4) due to skewing of the resilient material and not due to sliding in the contact area. The thickness of the resilient layer (10) is chosen taking into consideration the relative movement permissible The cables comprise at least one currentcarrying conductor (6), a first layer (7) having semiconductive properties provided around said conductor (6) a solid

The present invention relates to rotating electrical machines, e.g. synchronous machines, but also to dual-fed machines, applications in asynchronous static current converter cascades, outerpole machines and synchronous flow machines. The invention relates to a device for avoiding wear between the cables in coil-end packages on the stator in a rotating electric machine. The device according to the invention is designed for use with high voltages, by which is meant electric voltages exceeding 10 kV. A typical working range for the device according to the invention may be 36-800 kV. The problem addressed by the invention appears in connection with a high-voltage electric alternating current machine, primarily intended as generator in a power station for generating electric power. Such machines have conventionally been designed for voltages in the range 15-30 kV and 30 kV has normally been considered to be an upper limit. This generally means that a generator must be connected to the power network via a transformer which steps up the voltage to the level of the power network, i.e. in the range of 130-400 kV.

### BACKGROUND ART

### THE PROBLEMS

The problems addressed by the invention can be exemplified in connection with a high voltage electric alternating current machine. Such machine can be a generator in a power station for generating electric power. Conventionally such machines were designed for voltages in the range 15-30 kV and 30 kV has normally been considered to be an upper limit. This means that generally a generator must be connected to a power network via a transformer which steps up the voltage to the level of the power network.

In order to design a rotating electric machine for higher voltages, the ac windings of the stator have to form several layers with gradually increasing radius, thus permitting a build-up of higher voltages without undue increase of the layer-to-layer voltage. This means that the end windings on a stator have to accommodate several, and at least more than two, layers for each winding. There are many problems with increasing the number of layers in the end windings. The electric field surrounding the end windings cause problems since the field will deviate from its radial extension around the conductors in the stator to an axial extension when layers in the end windings. The electric field surrounding the end windings cause problems since the field will deviate from its radial extension around the conductors in the stator to an axial extension when outside the stator. These problems are normally reduced by so called field control arrangements. In increasing the number of layers, the field control arrangements become excessively complex.

Certain attempts to a new approach as regards the design of synchronous machines are described, inter alia, in an article entitled “Water-and-oil-cooled Turbogenerator TVM-300” in J. Elektrotechnika,No. 1, 1970, pp 6-8, in U.S. Pat. No. 4,429,244 “Stator of Generator” and in Russian patent document CCCP Patent 955369.

The water- and oil-cooled synchronous machine described in J. Elektrotechnika is intended for voltages up to 20 kV. The article describes a new insulating system consisting of oil/paper insulation, which makes it possible to immerse the stator completely in oil. The oil can then be used as a coolant while at the same time using it as insulation. To prevent oil in the stator from leaking out towards the rotor, a dielectric oil-separating ring is provided at the internal surface of the core. The stator winding is made from conductors with an oval hollow shape provided with oil and paper insulation. The coil sides with their insulation are secured to the slots made with rectangular cross section by means of wedges. As coolant, oil is used both in the hollow conductors and in holes in the stator walls. Such cooling systems, however, entail a large number of connections of both oil and electricity at the coil ends. The thick insulation also entails an increased radius of curvature of the conductors, which in turn results in an increased size of the winding overhang.

The above mentioned US patent relates to the stator part of a synchronous machine which comprises a magnetic core of laminated sheet with trapezoidal slots for the stator winding. The slots are tapered since the need of insulation of the stator winding is smaller towards the interior of the rotor where that part of the winding which is located nearest the neutral point is disposed. In addition, the stator part comprises a dielectric oil-separating cylinder nearest the inner surface of the core which may increase the magnetization requirement relative to a machine without this ring. The stator winding is made of oil-immersed cables with the same diameter for each coil layer. The layers are separated from each other by means of spacers in the slots and secured by wedges. What is special for the winding is that it comprises two so-called half-windings connected in series. One of the two half-windings is disposed, centered, inside an insulation sleeve. The conductors of the stator winding are cooled by surrounding oil. The disadvantages with such a large quantity of oil in the system are the risk of leakage and the considerable amount of cleaning work which may result from a fault condition. Those parts of the insulation sleeve which are located outside the slots have a cylindrical part and a conical termination reinforced with current-carrying layers, the duty of which is to control the electric field strength in the region where the cable enters the end winding.

From CCCP 955369 it is clear, in another attempt to raise the rated voltage of the synchronous machine, that the oil-cooled stator winding comprises a conventional high-voltage cable with the same dimension for all the layers. The cable is placed in stator slots formed as circular, radially disposed openings corresponding to the cross-section area of the cable and the necessary space for fixing and for coolant. The different radially disposed layers of the winding are surrounded by and fixed in insulated tubes. Insulating spaces fix the tubes in the stator slot. Because of the oil cooling, an internal dielectric ring is also needed here for sealing the coolant against the internal air gap.

### SUMMARY OF THE INVENTION

### EXAMPLES

An object of the invention is to provide a rotating electric machine, which can be directly connected to a power network without an intermediate transformer and that the rotating machine can comprise several layers of winding arranged in such a way that the machine will not become excessively large and complex.

The above object can be fulfilled by a machine in accordance with claim 1.

By using high-voltage insulated electric conductors, in the stator winding, with permanent insulation, which comprises an inner layer, surrounding the conductor, with semiconducting properties and that the insulation is also provided with at least one additional outer layer, surrounding the insulation, with semiconducting properties. The inner semiconducting layer shall function in such a way as to even the potential of the electric field outside the inner layer and the outer layer shall on one part function in such a way as to evening the potential by connecting it to a selected potential and on the other part by enclosing the electric field around the conductors within the outer layer. Semiconducting properties in this context is a to material which has a considerably lower conductivity than an electric conductor but which does not have such a low conductivity that it is an insulator. For example, the inner and outer semiconducting layers may have a resistivity within the interval 10-6 Wcm-100 kwcm. By using only insulating layers which may be manufactured with a minimum of defects and, in addition, providing the insulation with an inner and an outer semiconducting layer, it can be ensured that the thermal and electric loads are reduced. the voltage of the machine can be increased to such levels that it can be connected directly to the power network without an intermediate transformer. The step-up transformer is thus eliminated. Another advantage is that the design of the insulation system will make it possible to arrange the layers of the windings more freely. At the end windings it is possible to let the layers cross each other and to mix layers of windings with different voltage. This makes it possible to make the machine more compact, even though it comprises several layers of windings.

Problems can arise in these high-voltage electric machines in that the cables have a tendency to vibrate, thereby causing the large end windings to vibrate in relation to each other with frequencies of double the frequency of the mains voltage, i.e. 100 Hz in power supply systems with a nominal mains frequency of 50 Hz and 120 Hz in power supply systems with a nominal mains frequency of 60 Hz, and with amplitudes of approximately 0.1 mm. This means that the cables, which are provided externally with a semi-conducting layer, with the help of which its potential in relation to the environment shall be defined, may easily be damaged due to wear against adjacent cables in the end windings. In order to minimize the fretting of the cables against each other the cables are held in fixed positions at the end windings by positioning means, in order to prevent fretting contact between the cables at the location where the cables cross.

The invention will now be described in more detail with reference to the accompanying drawings in which

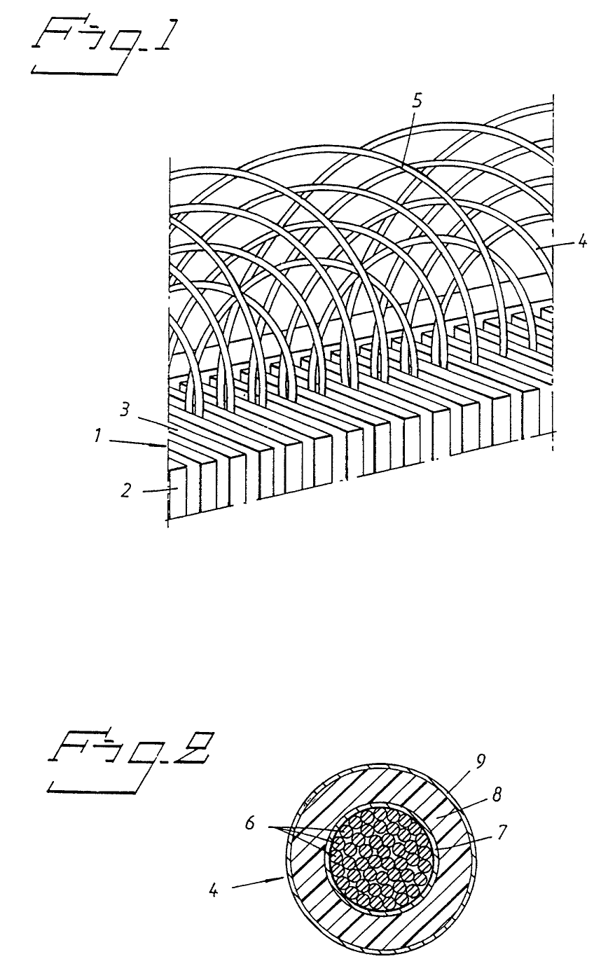

FIG. 1 shows a perspective view of a part of the coil-end package at one end of the stator in an electric alternating current generator,

FIG. 2 shows a cross section through a cable of the type used in the stator winding,

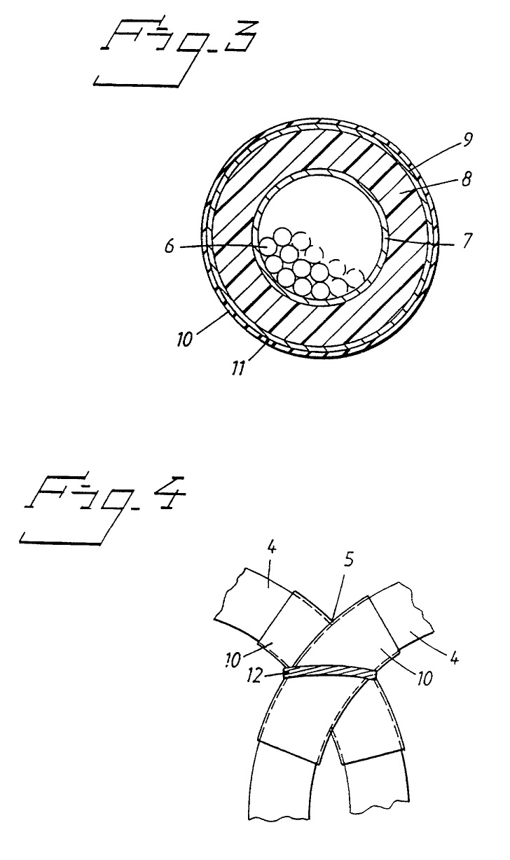

FIG. 3 shows a cross section through a cable in the end-coil stack with a device according to the present invention, and

FIG. 4 shows the contact area between two cables in the coil-end package.

FIG. 1 illustrates a portion of the coil-end package in an alternating current generator. With its inner vertical surface 2, the stator 1 surrounds the rotor of the generator with an air gap. Cables 4 forming the winding protrude from a slot in the upper surface 3 of the stator 1 to define an arc and enter another slot in the stator. These arcs of cables or coils form coil ends which come into contact with each other. One such contact point is designated 5 in FIG. 1. The arc-shaped coil ends become relatively loose and slippery and the vibration reached by the cables during operation with a frequency of approximately 100 Hz causes relative movement between the cables in the contact area, a relative movement with an amplitude of approximately 0.1 mm. Such movement would cause damaging wear between the cables which in this case have no sheath.

FIG. 2 shows a cross section of a cable 4 used in the present invention. The cable 4 comprises a conductor 6 with circular cross section, consisting of a number of strands and made of copper, for instance. This conductor 6 is arranged in the middle of the cable 4.

Around the conductor 6 is a first semi-conducting layer 7. Round the first semi-conducting layer 7 is an insulating layer 8 of XLPE insulation, for instance.

Around the insulation layer 8 is a second semiconducting layer 9. In this context a cable does not include the outer protective sheath which normally surrounds a cable for power distribution.

FIG. 3 shows a cross section through such a cable with a device according to the invention. In order to avoid wear between the cables in the contact area the cables there must be mutually secured while permitting relative movement which does not entail the cables sliding against each other and thus becoming worn. To this end the cables 4 are provided in the contact area with a rubber layer 10, suitably a tube or sleeve slit at 11 to enable it to be fitted onto the cables. The rubber material is not restricted to any particular material, but includes all any kind of material which is rubber-elastic. FIG. 4 shows how the cables have been secured to each other at the contact point 5 by means of a securing device in the form of a bundling tape 12. It is also suitable for the cables 4 to be similarly secured and clad with elastic even at outer, fixed points on the stator.

The thickness of the rubber layer in the sleeve 10 shall be sufficient to allow relative movement between the cables through skewing of the resilient material but without sliding between the surfaces. Wear of the cables is thus prevented, wear which would quickly damage the outer semi-conductor on the XLPE insulation. The thickness of the rubber layer may vary between 0.5 and 5 mm depending on the diameter of the cable, which may vary between 10 and 150 mm.

1. A rotating electric machine comprising a rotor, stator and windings, the windings being arranged in several layers and forming end windings outside the stator, characterized in that at least one of the windings comprise a flexible conductor surrounded by a solid insulation system comprising an inner layer with semiconducting properties, an insulating part and an outer layer with semiconducting properties and the at least one winding is arranged in such way that the end windings comprise layers crossing each other.

2. A rotating electric machine according to claim 1, characterized in that the layers are held in fixed positions at the end windings by positioning means, in order to prevent fretting contact between the layers at the location where the layers cross.

3. A rotating electric machine according to claim 2, characterized in that the positioning means comprise a resilient layer located in the contact area between two layers and a securing device, mutually securing the two layers, such that the resilient layer permit a certain relative movement between the layers due to skewing of the resilient material and not due to sliding in the contact area, the thickness of the resilient layer being chosen taking into consideration the permissible relative movement.

4. A rotating electric machine according to claim 3, characterized in that the resilient layer comprises a piece of slit rubber tubing clad around each layer in the contact area of the crossings.

5. A rotating electric machine according to claim 3 or 4, characterized in that the securing device comprises
a bundling tape wrapped around two layers at the contact location.

6. A rotating electric machine according to any one of claim 1-5, characterized in that the layers are held in fixed positions at outer attachment points in the stator.

7. A rotating electric machine according to any one of claim 1-6, characterized in that the positioning means are made of materials with defined resistivity such that it can be insulating or electrically conductive.

8. A rotating electric machine according to any one of the preceding claims, characterized in that the at least one winding comprises a cable.
